(19) United States
(12) Patent Application Publication
(10) Pub. No.: US 2016/0363079 A1
(43) Pub. Date: Dec. 15, 2016

(54) CONTROLLER FOR DIESEL ENGINE

(71) Applicant: DENSO CORPORATION, Kariya-city (JP)

(72) Inventor: Atsunori OKABAYASHI, Kariya-city (JP)

(21) Appl. No.: 15/176,471

(22) Filed: Jun. 8, 2016

(30) Foreign Application Priority Data
Jun. 11, 2015 (JP) 2015-118127

(51) Int. Cl. F02D 41/26

(52) U.S. Cl. CPC F02D 41/26

(57) ABSTRACT

A diesel engine is provided with a fuel injector which injects fuel into a combustion chamber. An ECU is provided with a kinematic viscosity obtaining portion which obtains a kinematic viscosity of the fuel, a fuel-density obtaining portion which obtains a density of the fuel, a component computing portion computing at least one of a carbon content and a hydrogen content contained in the fuel, based on the kinematic viscosity of the fuel and the density of the fuel, a fuel injection quantity determining portion determining whether a shortage or an overage of the actual fuel injection quantity arises relative to a required fuel injection quantity based on at least one of the carbon content and the hydrogen content, and a correction portion correcting the fuel injection quantity according to the shortage or the overage when the fuel injection quantity determining portion determines that the shortage or the overage of the actual fuel injection quantity arises.

### CROSS-REFERENCE TO RELATED APPLICATION

This application is based on Japanese Patent Application No. 2015-118127 filed on Jun. 11, 2015, the disclosure of which is incorporated herein by reference.

### TECHNICAL FIELD

The present disclosure relates to a controller for a diesel engine.

### BACKGROUND

Fuel for a diesel engine has wide property range, and a combustion condition is significantly varied according to the fuel property variation. Thus, due to the fuel property variation, a fuel injection period and a combustion period are varied, which causes deterioration in emission and a misfire. The combustion condition may become unstable.

JP-2006-226188A shows a fuel property detecting apparatus which detects the cetane value of the fuel based on the combustion condition of the fuel injected by a pilot injection.

However, even though the cetane value of the fuel is detected, it is likely that the deterioration in combustion condition may not be restricted by executing the combustion control according to the cetane value. For example, even though a fuel injector is opened for a specified period according to a required fuel injection quantity, it is likely that an actual fuel injection quantity may be overs or shorts relative to the required fuel injection quantity, which may cause deterioration in combustion condition.

### SUMMARY

It is an object of the present disclosure to provide a controller for a diesel engine, which is able to perform a proper fuel injection control even if a variation in fuel property exists.

According to the present disclosure, a controller for a diesel engine has a fuel injector which injects a fuel into a combustion chamber. Further, the controller has a kinematic viscosity obtaining portion which obtains a kinematic viscosity of the fuel; a fuel-density obtaining portion which obtains a density of the fuel; a component computing portion computing at least one of a carbon content and a hydrogen content contained in the fuel, based on the kinematic viscosity of the fuel and the density of the fuel; a fuel injection quantity determining portion determining whether a shortage or an overage of the actual fuel injection quantity arises relative to a required fuel injection quantity based on at least one of the carbon content and the hydrogen content; and a correction portion correcting the fuel injection quantity according to the shortage or the overage when the fuel injection quantity determining portion determines that the shortage or the overage of the actual fuel injection quantity arises.

The present inventor knows that the carbon content and the hydrogen content of the fuel are indexes which properly show the fuel injection condition. When the carbon content or the hydrogen content of the fuel increases or decreases due to the fuel property variation, the actual fuel injection quantity is excessively large or small relative to the required fuel injection quantity. Moreover, the present inventor knows that the carbon content and the hydrogen content of the fuel have high correlation with the fuel kinematic viscosity and the fuel density. Based on the fuel kinematic viscosity and the fuel density, at least one of the carbon content and the hydrogen content which are contained in the fuel is computed. Based on at least one of the carbon content and the hydrogen content, it is determined whether the actual fuel injection quantity is excessively large or small relative to the required fuel injection quantity. When the actual fuel injection quantity is excessively large or small, the fuel injection quantity is corrected. Thus, the proper injection quantity control can be performed in view of the fuel property variation.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view showing a diesel engine control system;

FIG. 2 is a distribution chart showing a distribution of the fuel with respect to a fuel density and a cetane value;

FIG. 3 is a distribution chart showing a distribution of the fuel with respect to a kinematic viscosity and a distillation temperature of a fuel;

FIG. 4 is a graph showing a relationship between an average carbon number and a distillation temperature of a fuel;

FIG. 5 is a graph showing a relationship between a lower calorific value and a ration “C/H”; and

FIG. 6 is a flowchart showing a processing of a fuel injection control.

### DETAILED DESCRIPTION

Hereinafter, embodiments of a controller for a diesel engine will be described. The same parts and components as those in each embodiment are indicated with the same reference numerals and the same descriptions will not be reiterated.

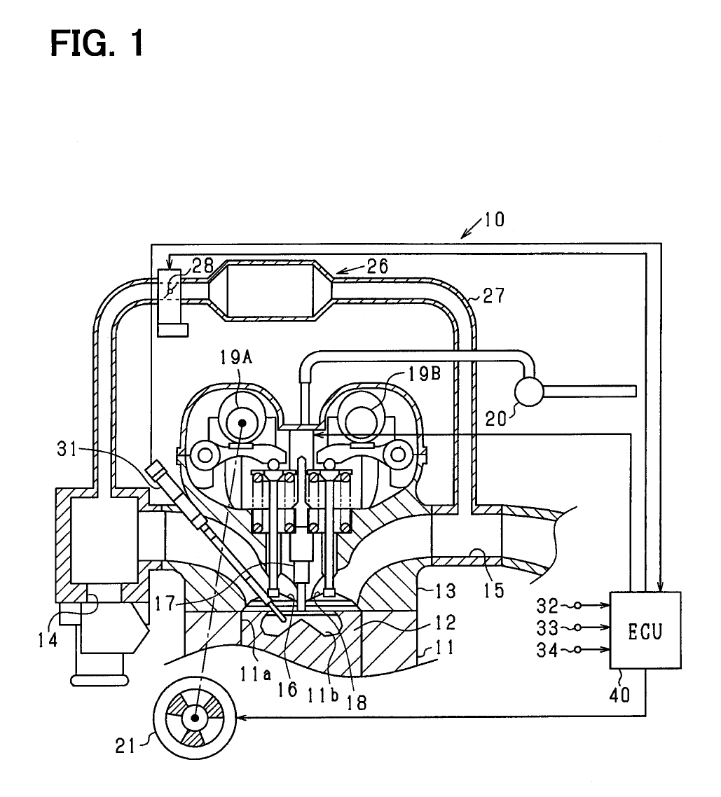

Referring to FIG. 1, a configuration of a diesel engine 10 will be described. The diesel engine 10 is an in-series four-cylinder diesel engine. FIG. 1 shows only one cylinder. The diesel engine 10 has a cylinder block 11, a piston 12, a cylinder head 13, an intake passage 14, an exhaust passage 15, an intake valve 16, a fuel injector 17, an exhaust valve 18, a variable valve timing mechanism 21, and an EGR system 26.

The cylinder block 11 forms four cylinders 11a therein. A piston 12 reciprocates in each cylinder 11a. The cylinder head 13 is provided on the cylinder block 11. A cavity (concave) is formed on a top surface of the piston 12, which defines a combustion chamber 11b.

The intake passage 14 communicate with each cylinder 11a through a passage defined in an intake manifold and the cylinder head 13. Cam shafts 19A, 19B are rotated by a crankshaft (not shown) of the diesel engine 10. Each intake valve 16 is driven by the cam shaft 19A. According to the driving of the intake valve 16, the intake air is introduced into the combustion chamber 11b. The variable valve timing mechanism 21 adjusts a valve timing of the intake valve 16.

The exhaust passage 15 communicates with each cylinder 11a through a passage defined in an exhaust manifold and the cylinder head 13. Each exhaust valve 18 is driven by the cam shaft 19B. According to the driving of the exhaust valve 18, the exhaust gas is discharged from the combustion chamber 11b.

A common-rail 20 accumulates the high-pressure fuel therein. The high-pressure fuel is supplied to the common-rail 20 by a fuel pump (not shown). The fuel injector 17 injects the fuel in the common-rail 20 into the combustion chamber 11b. The fuel injector 17 is a well-known electromagnetic valve or a piezo drive valve which controls fuel injection quantity by controlling a pressure in a control chamber biasing the nozzle needle in a close direction. A valve-opening period of the fuel injector 17 is controlled based on an energization period of an electromagnetic actuator or a piezo drive actuator. As the valve-opening period becomes longer, the injected fuel quantity becomes larger.

The EGR system 26 (exhaust gas recirculation system) is provided with an EGR passage 27 and an EGR valve 28. The EGR passage 27 connects the exhaust passage 15 and the intake passage 14. An EGR valve 28 is provided in the EGR passage 27 to open/close the EGR passage 27. The EGR system 26 introduces a part of the exhaust gas in the exhaust passage 15 into the intake air in the intake passage 14 according to an opening degree of the EGR valve 28.

During an intake stroke, a fresh air is introduced into the cylinder 11a through the intake passage 14. During the compression stroke, the air is compressed by the piston 12. Around the compression top dead center, the fuel injector 17 injects the fuel into the cylinder 11a (combustion chamber 11b). During the power stroke, the injected fuel is self-ignited. During the exhaust stroke, the exhaust gas is discharged through the exhaust passage 15. A part of the exhaust gas in the exhaust passage 15 is introduced into the intake air in the intake passage 14 by the EGR system 26.

The engine 10 is provided with a cylinder pressure sensor 31. The intake pressure sensor 23 detects pressure (negative pressure) in an intake pipe 34. It is not always necessary to provide the cylinder pressure sensor 31 to all cylinders 11a. At least one of the cylinders 11a is provided with the cylinder pressure sensor 31. A fuel density sensor 32, a kinematic viscosity sensor 33, and a fuel quantity sensor 34 are provided to a fuel tank (not shown) of the diesel engine 10. The fuel density sensor 32 detects the density of the fuel supplied to the fuel injector 17. The fuel density sensor 32 detects the density of the fuel, for example, based on a natural vibration period measuring method. The kinematic viscosity sensors 33 are a capillary viscometer or a kinematic viscosity meter based on a thin wire heating method, which detects the kinematic viscosity of the fuel in a fuel tank. The fuel quantity sensor 34 detects the quantity of the fuel in the fuel tank. It should be noted that the fuel density sensor 32 and the kinematic viscosity sensor 33 are provided with a heater which heats the fuel up to a specified temperature. Under such a condition, the fuel density and the fuel kinematic viscosity are detected.

An electric control unit (ECU) 40 is a well-known computer having a CPU, a ROM, a RAM, and an I/O, which controls the diesel engine 10. The ECU 40 controls the fuel injector 17, the variable valve timing mechanism 21 and the EGR system 26 based on detected values of the various sensors, such as a crank angle sensor, a cooling-water-temperature sensor, an accelerator position sensor, the cylinder pressure sensor 31, the fuel density sensor 32, the kinematic viscosity sensor 33, and the fuel quantity sensor 34. Specifically, the control conditions of the fuel injector 17, the variable valve timing mechanism 21 and the EGR system 26 are adapted to optimize the fuel combustion condition for a standard property fuel. The ECU 40 controls each apparatus based on the detected values of the various sensors so as to obtain the optimum fuel combustion condition (normal combustion control).

Also, the ECU 40 performs various programs stored in the ROM, whereby the ECU 40 functions as a kinematic viscosity obtaining portion, a fuel-density obtaining portion, a component computing portion, a fuel injection quantity determining portion, and a correction portion.

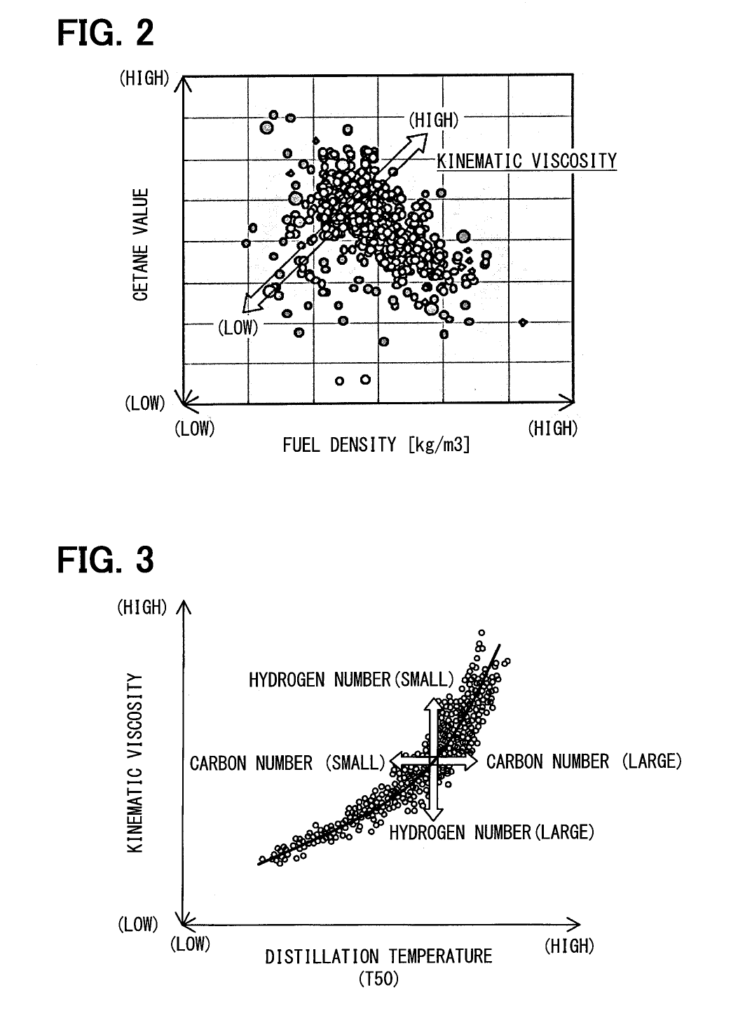

FIG. 2 is a distribution chart showing a distribution of the fuel with respect to a fuel density and a cetane value. The fuel used for the engine 10 (diesel engine) contains variations in fuel density and cetane value. Even if the cetane value is the same value, a difference may arise in the fuel density. Moreover, in the distribution chart of FIG. 2, a distribution tendency changes according to the kinematic viscosity of the fuel. As the kinematic viscosity is higher, the fuel density is higher. As the kinematic viscosity is lower, the fuel density is lower. Moreover, as the kinematic viscosity is lower, a range of the cetane value becomes narrower. As the kinematic viscosity is higher, the range of the cetane value becomes wider.

That is, although the cetane value is an index showing the ignitability, it is insufficient as an index which denotes the fuel property. Even if the fuel injection quantity, the valve timing of the intake valve 16 and the EGR quantity (exhaust gas recirculation quantity) are controlled according to the cetane value, it is likely that the fuel combustion may not be controlled appropriately.

The present inventor knows that the carbon content and the hydrogen content of the fuel are indexes which properly show the fuel injection condition. That is, the carbon number and the hydrogen number contained in the fuel are indexes which properly show the fuel injection condition. Moreover, the present inventor knows that the fuel distribution has a variation depending on the carbon number and the hydrogen number in a case that the fuel property is expressed by the kinematic viscosity and the distillation temperature of the fuel.

FIG. 3 shows a fuel distribution by using of parameters of the kinematic viscosity and a distillation temperature (T50: 50% capacity distillation temperature [° C.]) of the fuel. It is recognized that the fuel distribution is generated according to the component of the fuel. With respect to a specified kinematic viscosity, a range of the distillation temperature (T50) corresponds to a range of the carbon number. The fuel having large carbon number exists in a range where the distillation temperature (T50) is relatively high. The fuel having small carbon number exists in a range where the distillation temperature (T50) is relatively low. Moreover, the variation in kinematic viscosity is mainly generated due to the variation in hydrogen number. The fuel having low hydrogen number exists in a range where the kinematic viscosity is relatively high. The fuel having high hydrogen number exists in a range where the kinematic viscosity is relatively low.

With respect to the specified distillation temperature (T50), as the kinematic viscosity is lower, the fuel includes the component which has the larger hydrogen number. As the kinematic viscosity is higher, the fuel includes the component which has the smaller hydrogen number. In this case, since the kinematic viscosity is varied according to a hydrogen branch in a molecular structure of a hydrocarbon, it is considered that the kinematic viscosity is varied according to the hydrogen number even if the carbon number is constant.

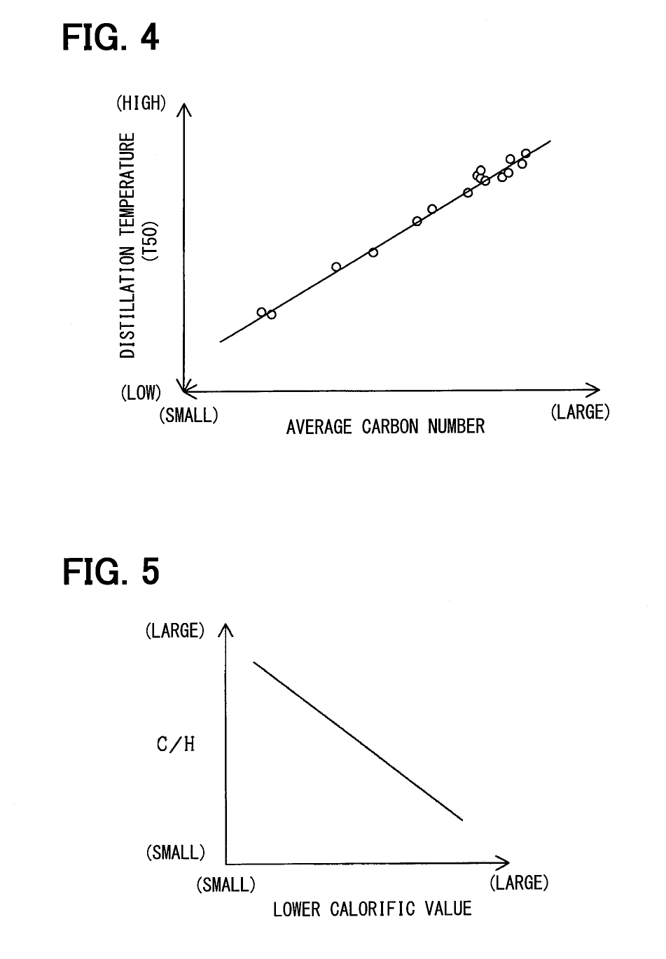

It should be noted that the carbon number and a boiling temperature have high correlation in hydrocarbon. As the carbon number is larger, the boiling temperature becomes higher. Moreover, as shown in FIG. 4, an average carbon number and the distillation temperature (T50) has a correlation with each other. As the average carbon number is larger, the distillation temperature (T50) becomes higher.

Also, the kinematic viscosity and the density of the fuel have a correlation with the lower calorific value of the fuel. The lower calorific value has a correlation with a ratio “C/H” which represents a ratio between a carbon quantity and a hydrogen quantity in the fuel. FIG. 5 shows the correlation between the lower calorific value and the ratio “C/H”.

According to the present embodiment, at least one of the carbon number and the hydrogen number of the fuel is computed in view of the relation shown in FIGS. 3 to 5. Based on at least one of the carbon number and the hydrogen number of the fuel, a fuel-injection quantity control is performed. Specifically, the ratio “C/H” is computed by using of parameters of the fuel density and the fuel kinematic viscosity. Then, the carbon number and the hydrogen number are computed based on the fuel kinematic viscosity and the ratio “C/H” in view of the relation shown in FIG. 3. Since the distillation temperature (T50) depends on the carbon number and the fuel kinematic viscosity depends on the hydrogen number, the fuel distribution can be corresponded to the ratio “C/H”. Further, the carbon number and the hydrogen number of the fuel can be computed by using of the parameter of the fuel kinematic viscosity.

Specifically, a correlation between the fuel kinematic viscosity and the hydrogen number is predetermined in a case that the carbon number of the fuel is a specified value. In view of the correlation, the hydrogen number of the fuel can computed based on the fuel kinematic viscosity and the ratio “C/H”. Moreover, according to the ratio “C/H” and the hydrogen number, the carbon number can be also computed. It should be noted that the carbon number can be replaced by the carbon quantity, and the hydrogen number can be replaced by the hydrogen quantity.

The kinematic viscosity and the density of the fuel can be detected by a kinematic viscosity sensor 33 and a density sensor 32, respectively. So, the carbon number and the hydrogen number of the fuel can be combusted.

Moreover, when the straight-chain of molecules contained in the fuel becomes short and the carbon number decreases, the hydrogen number relatively decreases, so that the fuel becomes incombustible. Considering the straight-chain and the side-chain of molecules, when the straight-chain of molecules contained in the fuel decreases, the side-chain of molecules increases, whereby the fuel becomes incombustible from a view point of a binding energy. In such a situation, it is considered that the actual fuel injection quantity is becomes excessively small relative to the required fuel injection quantity. That is, it is likely that torque of the engine 10 may become shortage. Meanwhile, when the hydrogen number relatively increases, the fuel is easily combusted. The actual fuel injection quantity may become excessive relative to the required fuel injection quantity, which may generate an excessive torque. According to the present embodiment, based on the carbon number and the hydrogen number, it is determined whether the actual fuel injection quantity is overs or shorts relative to the required fuel injection quantity. When it is determined that the actual fuel injection quantity is overs or shorts, the fuel injection quantity is corrected according to the overs and shorts.

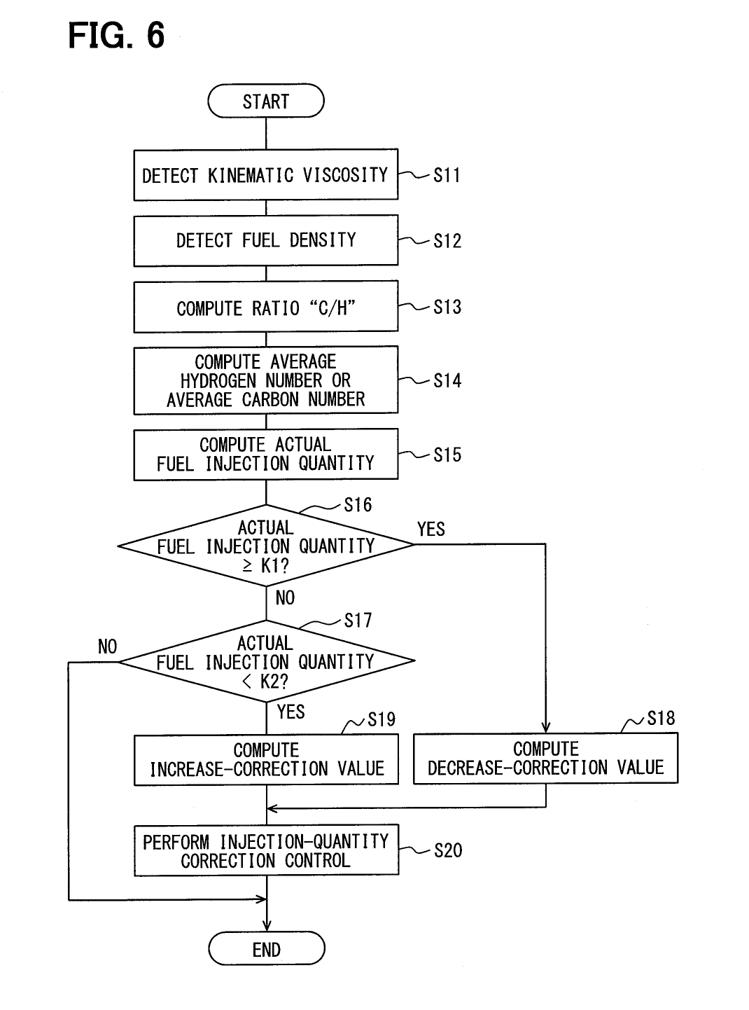

Referring to a flowchart shown in FIG. 6, a processing of a fuel injection control of the engine 10 will be described hereinafter. The processing is performed in a specified interval by the ECU 40, repeatedly. It should be noted that the processing for detecting the fuel property and for estimating the actual fuel injection quantity based on the fuel property are performed when refueling is conducted and an engine driving condition and a vehicle running condition are stable.

In S11, the kinematic viscosity of the fuel is detected by the kinematic viscosity sensor 33. In S12, the fuel density is detected by the fuel density sensor 32. In S13, the ratio “C/H” is computed in view of the correlation between the kinematic viscosity and the fuel density. The correlation is expressed by a correlation map or a correlation function. The map or the correlation function is stored in a memory of the ECU 40, in advance.

In S14, the average hydrogen number or the average carbon number of the fuel is computed based on the fuel kinematic viscosity and the ratio “C/H” in view of the correlation between the fuel kinematic viscosity and the hydrogen number of the fuel. The relation of the average hydrogen number or the average carbon number relative to the kinematic viscosity and the ratio “C/H” is defined as a map or a correlation function, in advance. Based on the map or the correlation function, the average hydrogen number or the average carbon number is computed.

In S15, the actual fuel injection quantity is computed in view of the predetermined map or the predetermined correlation function. Specifically, as the average hydrogen number is larger, the actual fuel injection quantity is computed as the smaller value. Alternatively, as the average carbon number is larger, the actual fuel injection quantity is computed as the larger value. The actual fuel injection quantity can be computed based on the correlation between both of the average carbon number and the average hydrogen number and the actual fuel injection quantity. The actual fuel injection quantity is computed as the fuel quantity which contributes to the torque generation of the engine 10.

In S16, it is determined whether the actual fuel injection quantity is greater than or equal to a first threshold K1. In S17, it is determined whether the fuel injection quantity is less than a second threshold K2. That is, it is determined whether the actual fuel injection quantity is excessive relative to the required fuel injection quantity in S16. It is determined whether the actual fuel injection quantity is excessively small relative to the required fuel injection quantity in S17. The first threshold K1 and the second threshold K2 are defined according to the required fuel injection quantity. The first threshold K1 is larger than the required fuel injection quantity, and the second threshold K2 is smaller than the required fuel injection quantity.

When the answer is YES in S16, the procedure proceeds to S18 in which a decrease-correction value is computed based on a difference between the actual fuel injection quantity and the required fuel injection quantity. As the difference is larger, the decrease-correction value is computed as a larger value. When the answer is YES in S17, the procedure proceeds to S19 in which an increase-correction value is computed based on a difference between the actual fuel injection quantity and the required fuel injection quantity. As the difference is larger, the increase-correction value is computed as a larger value.

Then, the procedure proceeds to S20 in which an injection-quantity correction control is performed. With respect to the fuel injection quantity computed based on the engine speed and the accelerator position, the correction is performed by using of the decrease-correction value or the increase-correction value. Based on the corrected fuel injection quantity, the fuel injector 17 injects the fuel.

Until a refueling is conducted, the fuel injection quantity is corrected by using of the same decrease-correction value or the same increase-correction value. The correction value may be adjusted according to the required fuel injection quantity.

When the actual fuel injection quantity is greater than or equal to the second threshold K2 and less than the first threshold K1, the injection-quantity correction control is not performed. That is, in this case, it is determined that the current fuel property is close to a standard fuel property. The injection-quantity correction control is not performed, and a normal fuel injection control is performed.

According to the above first embodiment, following advantages can be obtained.

The present inventor knows that the carbon number and the hydrogen number of the fuel are indexes which properly show the fuel injection condition. When the carbon number or the hydrogen number of the fuel increases or decreases due to the fuel property variation, the actual fuel injection quantity is too large or too small relative to the required fuel injection quantity. Moreover, the present inventor knows that the carbon number and the hydrogen number of the fuel have high correlation with the fuel kinematic viscosity and the fuel density. Based on the fuel kinematic viscosity and the fuel density, at least one of the carbon number and the hydrogen number which are contained in the fuel is computed. Based on at least one of the carbon number and the hydrogen number, it is determined whether the actual fuel injection quantity is too large or too small. When the actual fuel injection quantity is excessively large or small, the fuel injection quantity is corrected. Thus, the proper injection quantity control can be performed in view of the fuel property variation.

The fuel kinematic viscosity and the fuel density have a specified correlation with the ratio “C/H”. When the carbon number of the fuel is the same, the fuel kinematic viscosity and the hydrogen number have a specified correlation with each other. In view of this, the ratio “C/H” is computed based on the fuel kinematic viscosity and the fuel density. Further, based on the fuel kinematic viscosity and the ratio “C/H”, the hydrogen number can be computed.

When it is determined that the actual fuel injection quantity is greater than the required fuel injection quantity by a specified quantity, the fuel injection quantity is corrected to be decreased. Thus, even when the actual fuel injection quantity tends to be excessive, the fuel-injection quantity is properly controlled. Also, when it is determined that the actual fuel injection quantity is less than the required fuel injection quantity by the specified quantity, the fuel injection quantity is corrected to be increased. Thus, even when the actual fuel injection quantity tends to be excessively small, the fuel-injection quantity is properly controlled.

### Other Embodiment

The above-mentioned embodiment may be modified as follows.

The carbon number, the hydrogen number and the correction value are obtained at least once after refueling. However, considering a fuel property variation before refueling, the carbon number, the hydrogen number and the correction value may be periodically obtained. For example, they are obtained every predetermined time or every specified mileage of a vehicle.

It is not always necessary to obtain the fuel kinematic viscosity by the kinematic viscosity sensor 33. For example, the fuel pressure in the fuel passage from the common-rail to the fuel injector 17 is detected by a pressure sensor, and the pressure waveform is obtained from the detected fuel pressure. The velocity of the obtained pressure waveform is computed, and the fuel density is computed based on the velocity of the obtained pressure waveform. Based on the fuel density, the fuel kinematic viscosity may be computed. JP-2014-148906A shows the above in detail. Also, the fuel pressure in the common-rail 20 is detected by the pressure sensor, and the fuel kinematic viscosity may be computed based on the pressure waveform in the common-rail 20.

When the actual fuel injection quantity is excessively larger or small, this information may be stored in a storage device of the ECU 40. Also, this information may be noticed by a loudspeaker or a display. The threshold for determining a fuel property can be established other than the above thresholds K1, K2. The first threshold K1 may be replaced by a threshold Ka which is larger than the first threshold K1. The second threshold K2 may be replaced by a threshold Kb which is smaller than the second threshold K2.

What is claimed is:

1. A controller for a diesel engine having a fuel injector which injects a fuel into a combustion chamber, comprising:
a kinematic viscosity obtaining portion which obtains a kinematic viscosity of the fuel;
a fuel-density obtaining portion which obtains a density of the fuel;
a component computing portion computing at least one of a carbon content and a hydrogen content contained in the fuel, based on the kinematic viscosity of the fuel and the density of the fuel;
a fuel injection quantity determining portion determining whether a shortage or an overage of the actual fuel injection quantity arises relative to a required fuel injection quantity based on at least one of the carbon content and the hydrogen content; and
a correction portion correcting the fuel injection quantity according to the shortage or the overage when the fuel injection quantity determining portion determines that the shortage or the overage of the actual fuel injection quantity arises.

2. A controller for a diesel engine, according to claim 1, wherein
the component computing portion includes
a first computing portion which computes a ratio between the carbon content and the hydrogen content based on the kinematic viscosity of the fuel and the density of the fuel in view of a correlation between the ratio and both of the kinematic viscosity and the density, and
a second computing portion which computes the hydrogen content contained in the fuel based on the kinematic viscosity of the fuel and the ratio in view of a correlation between the kinematic viscosity and the hydrogen content.

3. A controller for a diesel engine, according to claim 1, wherein
the correction portion corrects the fuel injection quantity to be decreased when it is determined that the actual fuel injection quantity is greater than the required fuel injection quantity by a specified quantity, and
the correction portion corrects the fuel injection quantity to be increased when it is determined that the actual fuel injection quantity is less than the required fuel injection quantity by the specified quantity.
